(19) United States
(12) Patent Application Publication
(10) Pub. No.: US 2026/0338334 A1
(43) Pub. Date: Oct. 29, 2026

(54) LIGHTING APPARATUS

(71) Applicant: LINEA LIGHT SRL, Vazzola (IT)

(72) Inventor: Mauro Furlanetto, Fontanelle (IT)

(73) Assignee: LINEA LIGHT SRL, Vazzola (IT)

(21) Appl. No.: 19/116,253

(22) PCT Filed: Sep. 28, 2023
(86) PCT No.: PCT/EP2023/076962

§ 371 Date: Mar. 27, 2025

(30) Foreign Application Priority Data
Sep. 29, 2022 (EP) 22425044.9

(51) Int. Cl. F21S 4/22; F21V 15/01; F21Y 103/10; F21Y 115/10

(52) U.S. Cl. CPC F21S 4/22; F21V 15/01; F21Y 2103/10; F21Y 2115/10

(57) ABSTRACT

Lighting apparatus (10), comprising a flexible profile (11) made of thermoplastic material and provided with a first seating (12) for housing a light source (13a, 13b) and a second seating (14) for housing an electronic device (15) for piloting and/or controlling such light source (13a, 13b).

### FIELD OF THE INVENTION

The present invention concerns a lighting apparatus, in particular for outdoor use, possibly suitable to be walked over and driven over, and with linear LED lighting, preferably with indirect light emission.

### BACKGROUND OF THE INVENTION

Currently, rigid linear systems are on the market for the creation of continuous lines of light, with the possibility of inserting power and/or control electronics.

Due to their rigidity, known systems have the major limitation that they cannot be used in the creation of curved lines of light but only straight or at most angular ones. This is because they use elements of metal or rigid extruded plastic to make the support profiles of the LED strips.

Possible flexible solutions can be made using simple LED strips, but these have the major limitation that they cannot incorporate any power and/or control electronics.

The latter solution in most cases does not have the characteristics of robustness, such as walkability and drive-over, that the market requires in this type of installation. Even the laying of a strip is complex due, in most cases, to the absence of a supporting external casing which is itself flexible.

Known linear lighting systems equipped with piloting and/or control electronics are therefore not very flexible and substantially unsuitable to create lines of light of any shape, therefore including two-dimensional and/or three-dimensional curved shapes, of regular or irregular shape or other, especially in an outdoor environment.

Known lighting systems with LED strips, although they have a certain flexibility, are not very robust, therefore they are substantially unsuitable for outdoor use in situations where walkability and drive-over are required, nor are they equipped with piloting and/or control electronics.

Document CN 213872315 U describes a lamp including a mounting component and a lighting component located in the mounting component. Document DE 202019107018 U1 describes a lighting system with translucent cover element. Document CN 212901033 U describes an integrally-formed flexible LED lens lamp strip. Document US 2013/094225 A1 describes a linear LED light housing. Document EP 3604913 A1 describes a lighting device.

There is therefore a need to perfect a lighting apparatus which can overcome at least one of the disadvantages of the state of the art.

In particular, one purpose of the present invention is to provide a lighting apparatus which is robust, therefore possibly suitable to be walked and driven over, adaptable to the various installation requirements, in particular outdoors, and which allows to create lines of light of any shape, therefore also curved two-dimensional and/or three-dimensional shapes, of regular or irregular shape or other.

Another purpose of the present invention is to provide a lighting apparatus which is efficient and which includes inside it the electronic systems for controlling and/or piloting the light source provided therein.

Another purpose of the present invention is to provide a lighting apparatus

which is equipped with a flexible profile and which can be assembled directly on site by carrying out simple cutting and drilling operations of said profile, together with equally simple wiring operations.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a lighting apparatus according to the present invention comprises a flexible profile, made of thermoplastic material and provided with a first seating for housing a light source and a second seating for housing an electronic device for piloting and/or controlling the light source. The first seating is positioned under a covering element made in said profile and suitable to shield direct light.

The lighting apparatus, thanks to the flexible profile of thermoplastic material, advantageously allows to create continuous lines of light, even curved and irregular, with a comfortable and non-glaring light emission, and it is also equipped with a control and/or piloting electronic device housed in the profile. Moreover, thanks to the covering element, the light source is protected and the direct light is shielded, thus guaranteeing an excellent glare-free visual comfort.

The assembly of the entire lighting apparatus can be performed directly on site by performing simple cutting and drilling operations of the flexible profile together with equally simple wiring operations.

The present lighting apparatus is also robust, therefore possibly suitable to be walked over, driven over and suitable for outdoor use.

According to another aspect of the invention, the thermoplastic material is a PVC compound, which can be recycled and easily painted.

According to another aspect of the invention, the lighting apparatus comprises one or more systems for attachment to an installation surface.

According to another aspect of the invention, the profile comprises a seating for housing the one or more attachment systems.

According to another aspect of the invention, the seating comprises an impression for the correct positioning of the one or more attachment systems.

According to another aspect of the invention, the light source is an LED strip, able to be inserted by interlocking or snap-in into the first seating.

According to another aspect of the invention, the first seating is split into a first housing for the installation of a first type of light source and into a second housing for the installation of a second type of light source.

According to another aspect of the invention, the profile comprises a lightening slot.

The invention also concerns a lighting assembly, comprising two or more lighting apparatuses joined by means of one or more connection devices.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 shows three-dimensional views of some examples of profiles that can be used in a lighting apparatus according to the present invention;

FIG. 2 is a section front view of one of the profiles of FIG. 1;

FIG. 3 is a section front view of a lighting apparatus which provides one of the profiles of FIGS. 1 and 2;

FIG. 4 is a three-dimensional and exploded view of the present lighting apparatus;

FIG. 5 is a three-dimensional view of an installation step of the present lighting apparatus;

FIG. 6 is a three-dimensional view relating to a possible installation of the present apparatus by means of a peg;

FIGS. 7a and 7b are three-dimensional views relating to assembly steps of the lighting apparatus;

FIG. 8 is a three-dimensional view of a lighting assembly according to the present invention;

FIG. 9 shows an example installation of some lighting apparatuses along a wall and a floor, in particular outdoors.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

We will now refer in detail to the possible embodiments of the invention, of which one or more examples are shown in the attached drawings, by way of a non-... limiting illustration. The phraseology and terminology used here is also for the purposes of providing non-limiting examples.

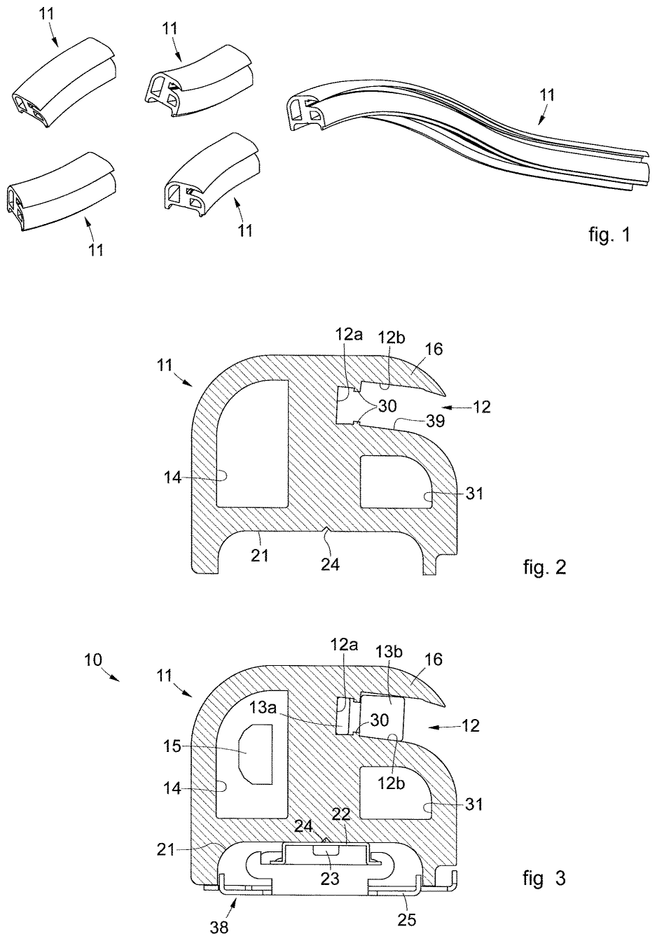

With reference to the attached drawings, please see in particular FIGS. 1, 2 and 3, a lighting apparatus 10 according to the present invention comprises a flexible profile 11, made of thermoplastic material and provided with a first seating 12 for housing a light source 13a, 13b and with a second seating 14 for housing an electronic device 15 for piloting and/or controlling the light source 13a, 13b.

The profile 11, as can be appreciated by observing FIG. 1 in particular, can assume various curvatures and be made in various lengths. The profile 11 can be for example curved in a two-dimensional plane and/or in a three-dimensional space, it can be shaped in such a way as to include rectilinear segments and curved segments, or other. Furthermore, the profile 11 can be cut to a desired length.

The thermoplastic material with which the profile 11 is made can preferably be a recyclable and easily paintable PVC (polyvinyl chloride) compound, therefore made for example with a PVC resin to which other components are added, for example plasticizing components, which give the product elasticity and flexibility, stabilizing components, which prevent aging and thermal degradation of the product, or other.

The profile 11 can be made for example by means of extrusion or other suitable process. The profile 11 preferably has a rough external surface, so that it can be painted, preferably at the installation site.

The first seating 12 can be split into two housings 12a, 12b, each suitable to contain a type of light source 13a, 13b, in particular an LED strip configured to be inserted by interlocking or snap-in into the corresponding seating 12a, 12b.

For example, the light source 13a can be a so-called “PU-C” LED strip with diffused optics.

For example, the light source 13 b can be a rubber LED strip with 27°/49° or diffused optics.

A first housing 12a is created at the bottom of the seating 12, while a second housing 12b is created adjacent to the first housing 12a and separated from it by means of reliefs 30. The light source 13b can, for example, abut against the reliefs 30.

Alternatively, it is possible to provide a seating 12 which is not split and suitable to house a type of light source 13a, 13b.

The first seating 12 is open toward the outside and can be shaped as a dovetail or in any other way that guarantees a stable and removable insertion, therefore by interlocking, snap-in or suchlike.

The first seating 12 is located in an upper zone of the profile 11 and is configured to allow the light source 13a, 13b to project a mostly indirect lighting, thus guaranteeing an excellent glare-free visual comfort. In this regard, the first seating 12 is positioned under a covering element 16 suitable to shield direct light. The covering element 16 forms, with the profile 11, a channel 39 for the insertion of the light source 13a, 13b into the first seating 12.

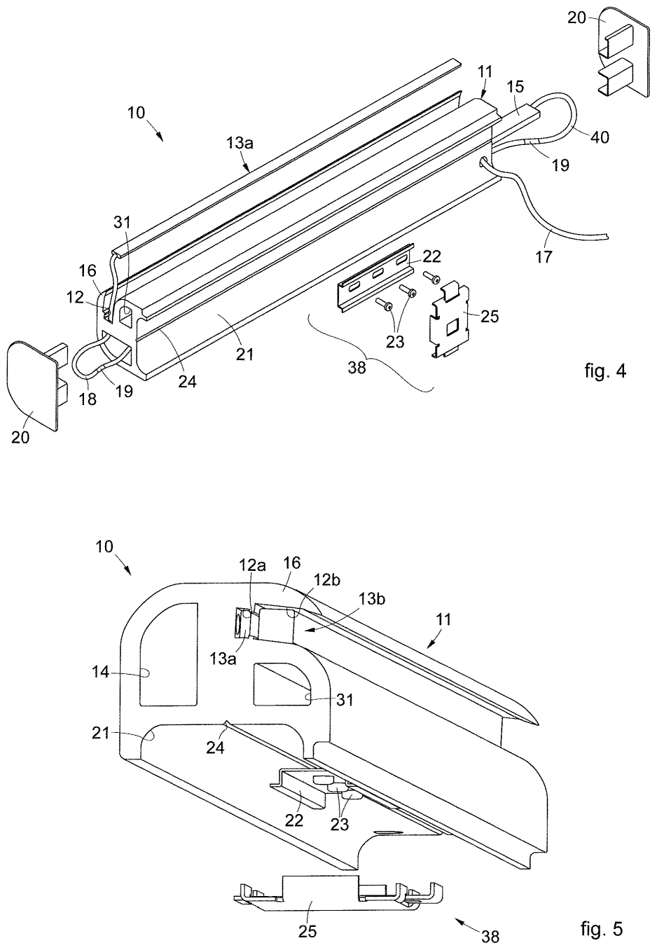

The second seating 14 is closed and is created inside the profile 11 in such a way that, inside it, it is possible to house the electronic device 15, an electric cable 17 for connection to the power supply network, and electric cables 18 and 40 for connection to the light source 13a, 13b and the electronic device 15, please see FIG. 4. The electric cables 17, 18, 40 can be reciprocally connected in a removable way by means of normal connectors 19, which can also be housed in the second seating 14.

As can be understood by observing the drawings, the seatings 12 and 14 run the entire length of the profile 11. The seatings 12 and 14 are therefore ultimately channels that pass through the entire profile 11 from one end to the other.

At the ends of the profile 11, there can be provided removable closing caps 20 to prevent dirt from entering.

With reference also to FIG. 5, the present lighting apparatus 10 comprises a system 38 for attachment to an installation surface, for example a wall, a floor or other. In particular, the attachment system 38 comprises a bracket 22 able to be associated with a quick coupling system 25, which is known per se and is able to be connected to said surface. As a function of the length of the profile 11, one or more attachment systems 38 will be provided, suitably positioned and spaced apart.

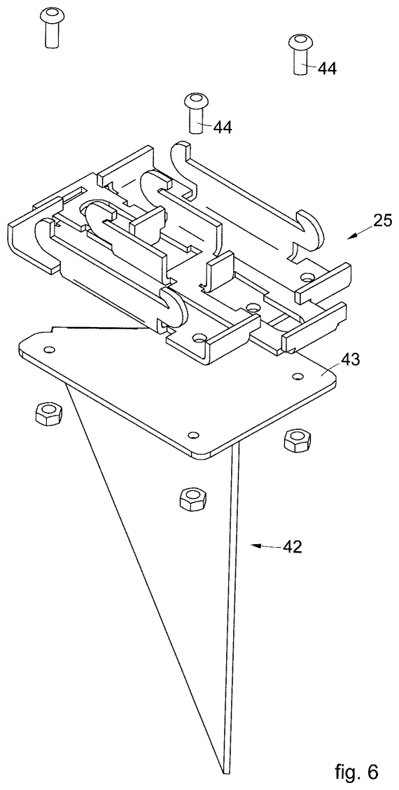

FIG. 6 shows the quick coupling system 25 applied to a peg 42 which allows the direct installation of the present lighting apparatus 11 to the ground. The quick coupling system 25 can be removably connected to a plate 43 associated with the peg 42 by means of attachment elements 44, such as bolts or suchlike.

The profile 11 comprises a seating 21 for housing the attachment system 38, in particular the bracket 22. The seating 21 is created in the rear part of the profile 11, that is, the part facing toward the installation surface.

The attachment of the bracket 22 to the seating 21 can be carried out for example by means of self-tapping screws 23 to be screwed along an impression 24 created in the seating 21. The impression 24 is rectilinear and extends along the entire profile 11 so as to guarantee a precise and correct positioning of the attachment system 38, in particular of the bracket 22. If more attachment systems 38 are provided along a same profile 11, the impression 24 guarantees their reciprocal alignment.

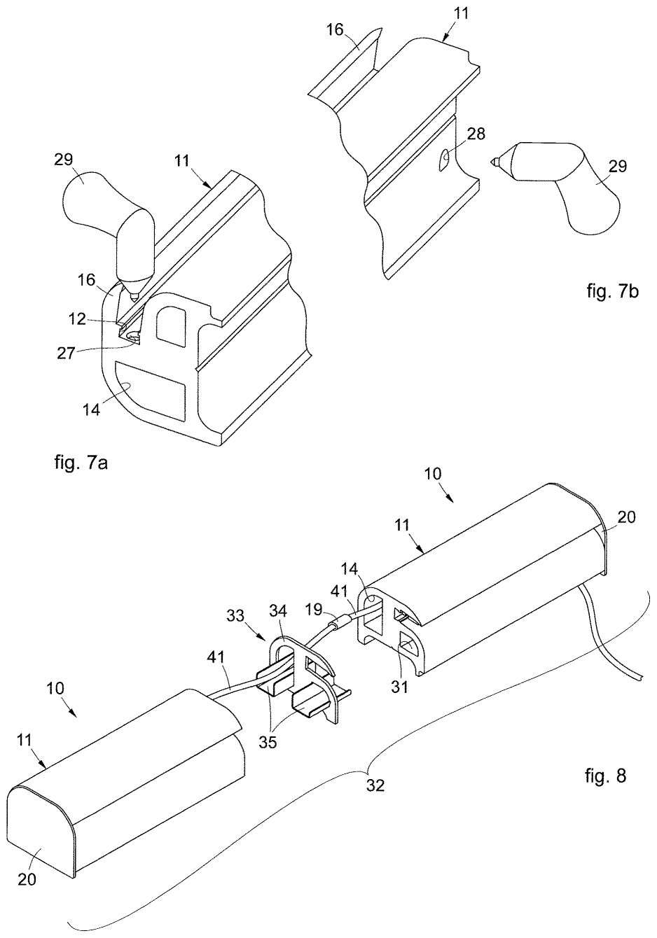

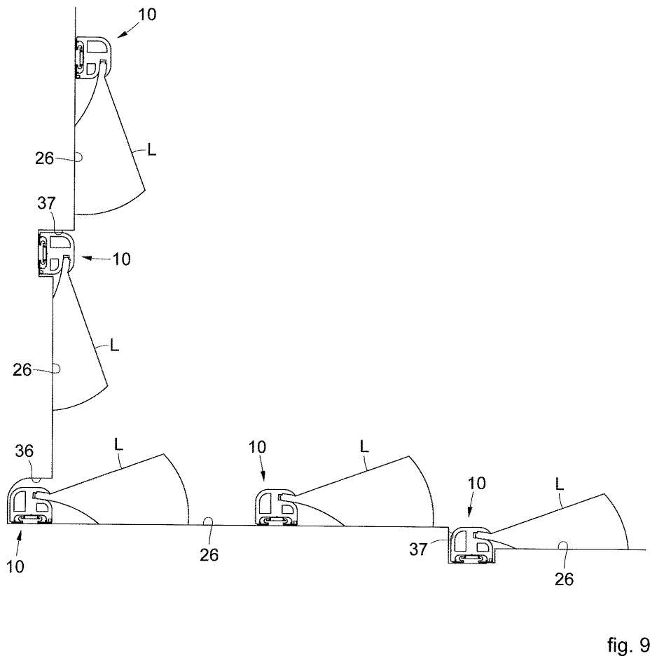

By making simple holes 27, 28 on site with a drill 29 or suchlike, please see FIGS. 7a, 7b, it is possible to make the electric cables 17, 18, 40 of FIG. 4 pass through the seatings 12 and 14, or outside the profile 11. The installation occurs in a very simple way, since the entire profile 11 already plays the role of external casing.

The profile 11 comprises a lightening slot 31 which can also be used, if necessary, for the passage of the electric cables. The slot 31 runs along the entire length of the profile 11.

FIG. 8 shows a lighting assembly 32 formed by a plurality of lighting apparatuses 10, for example two, but their number could of course be greater.

In particular, in order to be able to perform the function of creating continuous illuminated lines in the best possible way, there is provided the possibility of joining several lighting apparatuses 10 by using a suitable connection device 33. The connection device 33 can be for example an intermediate cap provided with a central part 34 for closing the reciprocally facing ends of the lighting apparatuses 10, and with protruding lateral elements 35 configured to be inserted in the profiles 11 of the lighting apparatuses 10, for example in the seating 14 and in the slot 31. The connection device 33 allows the passage of, for example, electric cables 41 for connection between the electronic devices 15 of the lighting apparatuses 10.

FIG. 8 shows, by way of example, examples of installation of lighting apparatuses 10 with corresponding luminous cones L on one or more surfaces 26.

The possible installation options are many and the present lighting apparatus 10 can be disposed in recessed or semi-recessed seatings 36 or 37, taking care to leave the light emission window open, or it can be positioned directly flush with the surfaces 26, or even on suitable supports, or other. The installation of the present lighting apparatus 10 can be carried out on surfaces 26 created in a floor, on walls, on ceilings or on a combination thereof.

The components of the present lighting apparatus 10, such as for example the electric cables 17, 18, 40, 41, the light source 13a, 13b, the electronic devices 15 and the connectors 19 are defined with an IP (International Protection) rating suitable for the type of installation expected, for example:
if external in a floor: IP67;
if external in a wall: IP65/66;
if internal or external subject to submersion: IP68.

The present lighting apparatus 10 is therefore ideal for creating continuous lines of light with an irregular and curved shape, thanks to the flexibility of the profile 11 of flexible thermoplastic material, all of which occurs directly during construction on site, in order to perfectly adapt the product to the location of installation. The lighting apparatus 10 advantageously comprises the light source 13a, 13b and the electronic piloting and/or control device 15, and it can be easily attached to the surface 26 by means of one or more attachment systems 38, equipped for example with brackets 22 associated with corresponding quick coupling systems 25.

It is clear that modifications and/or additions of parts may be made to the lighting apparatus as described heretofore, without departing from the field and scope of the present invention, as defined by the claims.

It is also clear that, although the present invention has been described with reference to some specific examples, a person of skill in the art shall certainly be able to achieve many other equivalent forms of lighting apparatus, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. A lighting apparatus (10), comprising a flexible profile (11) made of thermoplastic material and provided with a first seating (12) for housing a light source (13a, 13b) and a second seating (14) for housing an electronic device (15) for piloting and/or controlling said light source (13a, 13b), wherein said first seating (12) is positioned under a covering element (16) made in said profile (11) and suitable to shield direct light.

2. The lighting apparatus (10) of claim 1, wherein said first seating (12) is split into a first housing (12a) for an installation of a first type of light source (13a) and into a second housing (12b) for the installation of a second type of light source (13b).

3. The lighting apparatus (10) of claim 1, wherein said thermoplastic material is a recyclable and easily paintable PVC compound.

4. The lighting apparatus (10) of claim 1, wherein said lighting apparatus comprises one or more systems (38) for attachment to an installation surface (26).

5. The lighting apparatus (10) as in of claim 4, wherein said profile (11) comprises a seating (21) for housing said one or more attachment systems (38).

6. The lighting apparatus (10) of claim 5, wherein said seating (21) comprises an impression (24) for the correct positioning of said one or more attachment systems (38).

7. The lighting apparatus (10) of claim 1, wherein said light source (13a, 13b) is an LED strip, able to be inserted by interlocking or snap-in into said first seating (12).

8. The lighting apparatus (10) of claim 1, wherein said profile (11) comprises a lightening slot (31).

9. The lighting assembly (32) of claim 1, comprising two or more lighting apparatuses (10) joined by means of one or more connection devices (33).
